(19) United States
(12) Patent Application Publication
(10) Pub. No.: US 2025/0291875 A1
(43) Pub. Date: Sep. 18, 2025

(54) MATRIX ARITHMETIC CIRCUIT

(71) Applicant: Fujitsu Limited, Kawasaki-shi (JP)

(72) Inventor: Yutaka TAMIYA, Yokohama (JP)

(73) Assignee: Fujitsu Limited, Kawasaki-shi (JP)

(21) Appl. No.: 19/000,841

(22) Filed: Dec. 24, 2024

(30) Foreign Application Priority Data
Mar. 15, 2024 (JP) 2024-041312

(51) Int. Cl. G06F 17/16

(52) U.S. Cl. CPC G06F 17/16

(57) ABSTRACT

A matrix arithmetic circuit performs an operation of a matrix product and includes a plurality of second operators, each of which includes a plurality of first operators and an auxiliary operator coupled to each of the plurality of first operators, arranged in a lattice pattern. In each of the plurality of second operators, each of the plurality of first operators multiplies a submatrix generated by dividing a multiplier of the matrix product by a submatrix generated by dividing a multiplicand to calculate a submatrix product, and the auxiliary operator performs digit alignment and addition of the submatrix product calculated by each of the plurality of first operators.

### CROSS-REFERENCE TO RELATED APPLICATION

This application is based upon and claims the benefit of priority of the prior Japanese Patent Application No. 2024-41312, filed on Mar. 15, 2024, the entire contents of which are incorporated herein by reference.

### FIELD

The embodiment discussed herein is related to a matrix arithmetic circuit.

### BACKGROUND

Floating-point operations are frequently used in applications (high performance computing (HPC) applications) run in recent HPC and in applications (machine learning (ML) applications) for implementing ML.

Japanese Laid-open Patent Publication No. 2021-33813 is disclosed as related art.

### SUMMARY

According to an aspect of the embodiments, a matrix arithmetic circuit performs an operation of a matrix product and includes a plurality of second operators, each of which includes a plurality of first operators and an auxiliary operator coupled to each of the plurality of first operators, arranged in a lattice pattern. In each of the plurality of second operators, each of the plurality of first operators multiplies a submatrix generated by dividing a multiplier of the matrix product by a submatrix generated by dividing a multiplicand to calculate a submatrix product, and the auxiliary operator performs digit alignment and addition of the submatrix product calculated by each of the plurality of first operators.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an arithmetic circuit according to an embodiment;

FIGS. 2A and 2B are diagrams for explaining a Wallace tree;

FIGS. 3A and 3B are diagrams illustrating a configuration of the Wallace tree;

FIGS. 4A and 4B are diagrams illustrating a configuration of the Wallace tree;

FIGS. 5A and 5B are diagrams illustrating a configuration of the Wallace tree;

FIG. 6 is a diagram exemplifying a Wallace tree for a 53×53 bit integer multiplier including four Wallace trees for a 24×24 bit integer multiplier;

FIG. 7 is a layout diagram of the Wallace tree exemplified in FIG. 6; and

FIG. 8 is a diagram illustrating a configuration of each Wallace tree of four low-precision multipliers and an auxiliary operator included in the Wallace tree for a 53×53 bit integer multiplier exemplified in FIGS. 6 and 7.

### DESCRIPTION OF EMBODIMENTS

Furthermore, while many of those HPC applications and ML applications use matrix product operations, the matrix product operation for calculating floating-point data needs a long calculation time, and thus, it is desirable to use an accelerator to accelerate the speed. Note that, in a common multiplication circuit for implementing the floating-point operation, processing by an integer multiplier for a mantissa part (mantissa or significand) takes the longest operation time.

Moreover, in the floating-point operation, numerical values of a plurality of degrees of precision (bit widths), such as 64-bit floating point (for example, FP-64), 32-bit floating point (for example, FP-32), 16-bit floating point (for example, FP-16), and the like are selectively used depending on the application. FP-32 multiplication needs 24×24 bit integer multiplication, and FP-64 multiplication needs 53×53 bit integer multiplication.

The circuit area increases when a plurality of arithmetic circuits supporting the respective degrees of precision is mounted on the accelerator to handle the floating-point operation with the plurality of degrees of precision. In addition, since the arithmetic circuit provided for unused precision does not operate, the usage rate of the operator also decreases.

In one aspect, an object of the embodiment is to reduce a circuit area of an arithmetic circuit capable of handling operations with a plurality of degrees of precision.

Hereinafter, an embodiment of the present matrix arithmetic circuit will be described with reference to the drawings. Note that the embodiment to be described below is merely an example, and there is no intention to exclude application of various modifications and techniques not explicitly described in the embodiment. For example, the present embodiment may be variously modified and implemented in a range that does not depart from the spirit thereof. Furthermore, each of the drawings is not intended to include only components illustrated in the drawing, and may include another function and the like.

### (A) Description of Basic Configuration

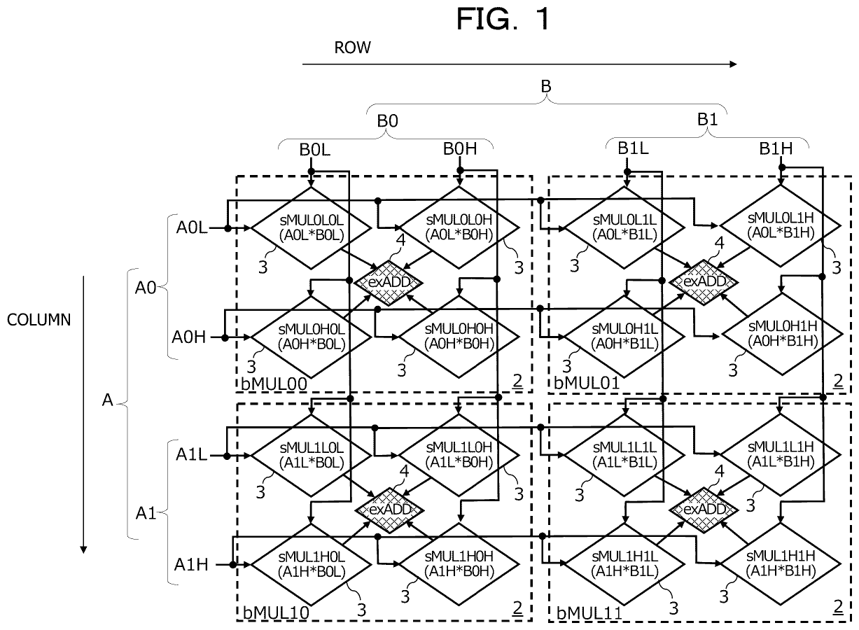

FIG. 1 is a diagram schematically illustrating a configuration of an arithmetic circuit according to an embodiment.

An arithmetic circuit 1 exemplified in this FIG. 1 is a multiplication circuit having a two-dimensional systolic array configuration, and performs an operation of a matrix product (X=A*B). In FIG. 1, the horizontal direction corresponds to the row direction, and the vertical direction corresponds to the column direction.

The present arithmetic circuit 1 handles operations with a plurality of degrees of precision (bit widths). In the present embodiment, it is assumed that the arithmetic circuit 1 is operable by switching between two types of operation modes including a low-precision calculation mode for processing data with first precision and a high-precision calculation mode for processing data with second precision higher than the first precision. The low-precision calculation mode is an example of a first calculation mode, and the high-precision calculation mode is an example of a second calculation mode.

The arithmetic circuit 1 includes a plurality of (four in the example illustrated in FIG. 1) high-precision multipliers 2. Hereinafter, the high-precision multiplier 2 may be denoted by a code bMUL. Furthermore, the high-precision multiplier 2 may be identified by a combination of the code bMUL and a unique identification value. In FIG. 1, the four high-precision multipliers 2 are denoted by codes bMUL00, bMUL01, bMUL10, and bMUL11. In those codes representing the high-precision multipliers 2, each of the numerical values 00, 01, 10, and 11 is an example of the identification value.

In the arithmetic circuit 1, the plurality of high-precision multipliers 2 is arranged in each of the row direction and the column direction by being arranged in a two-dimensional lattice pattern.

In the example illustrated in FIG. 1, bMUL10 and bMUL01 are arranged on the lower side of bMUL00 and on the right side of bMUL00, respectively. In addition, bMUL11 is arranged on the right side of bMUL10, which is on the lower side of bMUL01.

The high-precision multipliers 2 function in the high-precision calculation mode. Each of the high-precision multipliers 2 includes a plurality of (four in the example illustrated in FIG. 1) low-precision multipliers 3. Note that, in the low-precision calculation mode, the plurality of low-precision multipliers 3 included in the arithmetic circuit 1 functions as a two-dimensional systolic array as a whole. Processing as the two-dimensional systolic array based on the low-precision multipliers 3 in the low-precision calculation mode is already known, and descriptions thereof will be omitted.

Hereinafter, the low-precision multiplier 3 may be denoted by a code sMUL. Furthermore, the plurality of low-precision multipliers 3 may be identified by a combination of the code sMUL and a unique identification value.

In the example illustrated in FIG. 1, bMUL00 includes sMUL0L0L, sMUL0H0L, sMUL0L0H, and sMUL0H0H. In addition, bMUL10 includes sMUL1L0L, sMUL1H0L, sMUL1L0H, and sMUL1H0H. Moreover, bMUL01 includes sMUL0L1L, sMUL0H1L, sMUL0L1H, and sMUL0H1H. In addition, bMUL11 includes sMUL1L1L, sMUL1H1L, sMUL1L1H, and sMUL1H1H.

In those codes representing the low-precision multipliers 3, a character string formed by a combination of 0L, 1L, 0H, and 1H, such as 0L0H, is an example of the identification value.

In each of the high-precision multipliers 2, the plurality of low-precision multipliers 3 is arranged in a two-dimensional lattice pattern by being arranged in the row direction and the column direction. With this arrangement, in the arithmetic circuit 1, the plurality of low-precision multipliers 3 is disposed side by side in the row direction and the column direction. In the arithmetic circuit 1 exemplified in FIG. 1, 16 low-precision multipliers 3 are arranged in a lattice pattern of 4 rows×4 columns. In the arithmetic circuit 1, it may be said that the high-precision multipliers 2 and the low-precision multipliers 3 share the circuit. The high-precision multiplier 2 in which the plurality of (four in the example illustrated in FIG. 1) low-precision multipliers 3 is integrated operates as a high-precision two-dimensional systolic array circuit.

In the example illustrated in FIG. 1, in bMUL00, sMUL0H0L and sMUL0L0H are arranged on the lower side of sMUL0L0L and on the right side of sMUL0L0L, respectively. In addition, sMUL0H0H is arranged on the right side of sMUL0H0L, which is on the lower side of sMUL0L0H.

Likewise, in bMUL10, sMUL1H0L and sMUL1L0H are arranged on the lower side of sMUL1L0L and on the right side of sMUL1L0L, respectively. In addition, sMUL1H0H is arranged on the right side of sMUL1H0L, which is on the lower side of sMUL1L0H.

Furthermore, in bMUL01, sMUL0H1L and sMUL0L1H are arranged on the lower side of sMUL0L1L and on the right side of sMUL0L1L, respectively. In addition, sMUL0H1H is arranged on the right side of sMUL0H1L, which is on the lower side of sMUL0L1H. Moreover, in bMUL11, sMUL1H1L and sMUL1L1H are arranged on the lower side of sMUL1L1L and on the right side of sMUL1L1L, respectively. In addition, sMUL1H1H is arranged on the right side of sMUL1H1L, which is on the lower side of sMUL1L1H.

In the arithmetic circuit 1, the respective low-precision multipliers 3 arranged in the row direction are coupled by a signal line provided along the row direction, and the respective low-precision multipliers 3 arranged in the column direction are coupled by a signal line provided along the column direction.

Furthermore, each of the high-precision multipliers 2 includes an auxiliary operator 4. The auxiliary operator 4 is coupled to, via a communication line, all the low-precision multipliers 3 included in the high-precision multiplier 2 on which the auxiliary operator 4 is mounted (which may be referred to as high-precision multiplier 2 of its own). The auxiliary operator 4 may be denoted by a code exADD.

For example, the multiplier (A) of the matrix product and the multiplicand (B) of the matrix product are input to the arithmetic circuit 1 configured as described above from the left end of the two-dimensional lattice and from the upper end of the two-dimensional lattice, respectively, by being divided into a plurality of submatrices.

In the example illustrated in FIG. 1, the multiplier A is divided into two submatrices A0 and A1 (A=A0, A1). Furthermore, the submatrix A0 is divided into two submatrices A0L and A0H (A0=A0L, A0H), and the submatrix A1 is divided into two submatrices A1L and A1H (A1=A1L and A1H).

The submatrix A0L is lower bits of the submatrix A0, and the submatrix A0H is higher bits of the submatrix A0. In addition, the submatrix A1L is lower bits of the submatrix A1, and the submatrix A1H is higher bits of the submatrix A1. Hereinafter, the submatrices A0L and A1L will be referred to as a submatrix A #L when they are not particularly distinguished, and the submatrices A0H and A1H will be referred to as a submatrix A #H when they are not particularly distinguished. In addition, hereinafter, the submatrices A0 and A1 will be referred to as a submatrix A # when they are not particularly distinguished. However, # represents 0 or 1.

Then, the submatrix A0L is input to each of the respective low-precision multipliers 3 included in the row starting with sMUL0L0L. In addition, the submatrix A0H is input to each of the respective low-precision multipliers 3 included in the row starting with sMUL0H0L. Moreover, the submatrix A1L is input to each of the respective low-precision multipliers 3 included in the row starting with sMUL1L0L. In addition, the submatrix A1H is input to each of the respective low-precision multipliers 3 included in the row starting with sMUL1H0L.

Meanwhile, the multiplicand B is divided into two submatrices B0 and B1 (B=B0, B1). Furthermore, the submatrix B0 is divided into two submatrices B0L and B0H (B0=B0L, B0H), and the submatrix B1 is divided into two submatrices B1L and B1H (B1=B1L, B1H).

The submatrix B0L is lower bits of the submatrix B0, and the submatrix B0H is higher bits of the submatrix B0. In addition, the submatrix B1L is lower bits of the submatrix B1, and the submatrix B1H is higher bits of the submatrix B1. Hereinafter, the submatrices B0L and B1L will be referred to as a submatrix B #L when they are not particularly distinguished, and the submatrices B0H and B1H will be referred to as a submatrix B #H when they are not particularly distinguished. In addition, hereinafter, the submatrices B0 and B1 will be referred to as a submatrix B # when they are not particularly distinguished. The submatrices A #H, A #L, B #H, and B #L may be referred to as low-precision values. In addition, the submatrices A # and B # may be referred to as high-precision values.

Then, the submatrix B0L is input to each of the respective low-precision multipliers 3 included in the column starting with sMUL0L0L. In addition, the submatrix B0H is input to each of the respective low-precision multipliers 3 included in the column starting with sMUL0L0H. Moreover, the submatrix B1L is input to each of the respective low-precision multipliers 3 included in the column starting with sMUL0L1L. In addition, the submatrix B1H is input to each of the respective low-precision multipliers 3 included in the column starting with sMUL0L1H.

Note that the input submatrix may be sequentially propagated among the plurality of low-precision multipliers 3 included in the respective rows and columns.

Each of the low-precision multipliers 3 calculates a submatrix product by multiplying the input submatrix of the multiplier by the submatrix of the multiplicand.

Each of the low-precision multipliers 3 uses the low-precision value A #L or A #H and the low-precision value B #L or B #H as inputs to perform low-precision multiplication of the submatrix product (A #L*B #L, A #L*B #H, A #H*B #L, or A #H*B #H).

For example, in bMUL00, sMUL0L0L calculates a submatrix product (A0L*B0L) using the input submatrices A0L and B0L, and sMUL0H0L calculates a submatrix product (A0H*B0L) using the input submatrices A0H and B0L. In addition, sMUL0L0H calculates a submatrix product (A0L*B0H) using the input submatrices A0L and B0H, and sMUL0H0H calculates a submatrix product (A0H*B0H) using the input submatrices A0H and B0H.

In FIG. 1, individual submatrix products to be calculated by the respective low-precision multipliers 3 are indicated in parentheses.

In the arithmetic circuit 1, input according to the operation of the two-dimensional systolic array is performed in the low-precision calculation mode, and the submatrix products calculated by all the low-precision multipliers 3 are added, thereby obtaining the original matrix product (X=A*B).

On the other hand, in the high-precision calculation mode, each of the low-precision multipliers 3 inputs the calculated value of the submatrix product to the auxiliary operator 4 of the high-precision multiplier 2 of its own in each of the high-precision multipliers 2.

For example, the auxiliary operator 4 adds a bit that is not an input of the low-precision multiplier 3 in the high-precision input and a digit alignment result of the submatrix product calculated by each of the low-precision multipliers 3 mounted on the high-precision multiplier 2 of its own to calculate as a high-precision multiplication result. The input according to the operation of the two-dimensional systolic array is performed, and the submatrix products calculated by all the high-precision multipliers 2 included in the arithmetic circuit 1 are added, thereby obtaining the original matrix product (X=A*B).

### (B) Description of Application Example

Hereinafter, an example of applying the present arithmetic circuit 1 to operations (integer multiplications) with a plurality of degrees of precision will be described. Hereinafter, an example will be described in which each of the low-precision multipliers 3 is a partial sum adder circuit formed using the Wallace tree.

The Wallace tree may be configured by a collection of full adders (FAS). A full adder is a circuit with three bit values as inputs, one carry, and one output. The full adder may be expressed as (x, y, z)→(s, c).

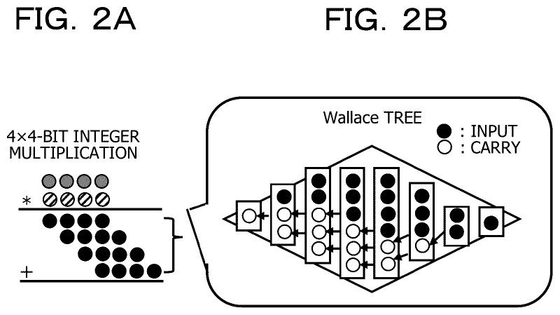

FIGS. 2A and 2B are diagrams for explaining the Wallace tree, in which FIG. 2A illustrates 4×4 bit integer multiplication and FIG. 2B illustrates the Wallace tree for implementing the 4×4 bit integer multiplication illustrated in FIG. 2A.

An integer multiplier calculates the 4×4 bit integer multiplication as binary calculation on paper. The Wallace tree is used to add a partial product for each digit.

When an input of a partial product of each digit is represented by a black circle and a carry from a lower digit is represented by a white circle in the diagram illustrated in FIG. 2A, the Wallace tree may be represented by rhombus arrangement as illustrated in FIG. 2B.

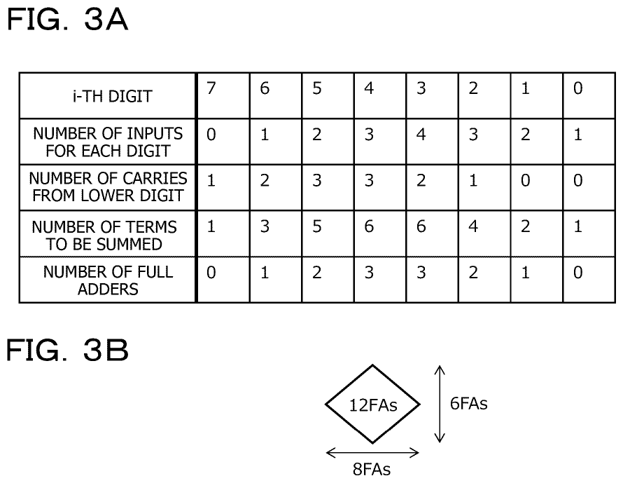

Each of FIGS. 3A to 5B is a diagram illustrating a configuration of the Wallace tree. In those FIGS. 3A to 5B, each of FIGS. 3A, 4A, and 5A illustrates numerical information representing the configuration of the Wallace tree, and each of FIGS. 3B, 4B, and 5B illustrates a size of the Wallace tree.

FIG. 3A illustrates, for each digit (i-th digit) of the Wallace tree used in the 4×4 bit integer multiplication, the number of inputs for each digit, the number of carries from a lower digit, the number of terms to be summed, and the number of full adders.

The area, height, and width of the Wallace tree may be obtained by the following equations (1), (2), and (3), respectively, when they are represented by the number of full adders. Note that N represents the number of bits. In addition, in each of the following equations, a unit is the number of full adders (FAS).

$$\begin{matrix}Area = N * ( N - 1 ) & ( 1 ) \\ Height = N * 2 - 2 & ( 2 ) \\ Width = N * 2 = 8 & ( 3 )\end{matrix}$$

Since N=4 in the case of the 4×4 bit integer multiplication, the area, height, and width are obtained as follows using the equations (1) to (3).
Area=12 (FAS)
Height=6 (FAS)
Width=8 (FAS)

The Wallace tree obtained in this manner has a size as illustrated in FIG. 3B.

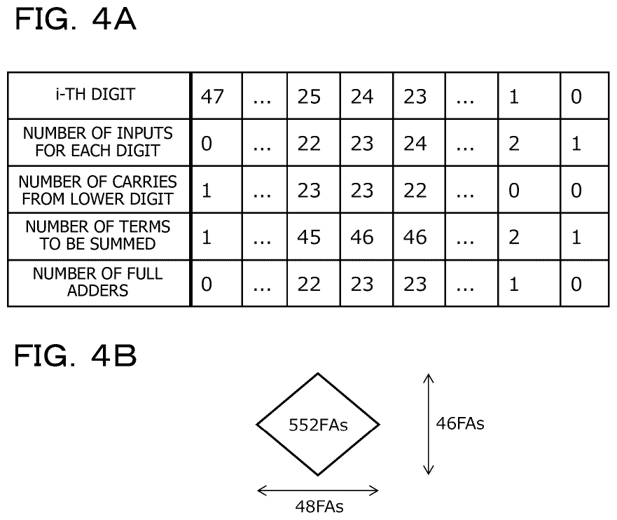

FIG. 4A illustrates, for each digit (i-th digit) of the Wallace tree used in 24×24 bit integer multiplication used in FP-32, the number of inputs for each digit, the number of carries from a lower digit, the number of terms to be summed, and the number of full adders.

The area, height, and width of the Wallace tree used in the 24×24 bit integer multiplication used in FP-32 are calculated based on the equations (1), (2), and (3) described above.

Since N=24 in the case of the 24×24 bit integer multiplication, the area, height, and width are obtained as follows using the equations (1) to (3).
Area=552 (FAs)
Height=46 (FAS)
Width=48 (FAS)

The Wallace tree obtained in this manner has a size as illustrated in FIG. 4B.

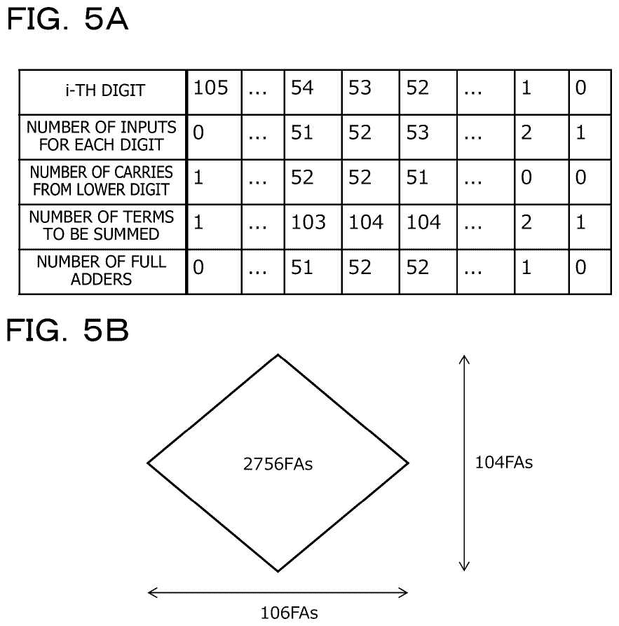

FIG. 5A illustrates, for each digit (i-th digit) of the Wallace tree used in 53×53 bit integer multiplication used in FP-64, the number of inputs for each digit, the number of carries from a lower digit, the number of terms to be summed, and the number of full adders.

The area, height, and width of the Wallace tree used in the 53×53 bit integer multiplication used in FP-64 are calculated based on the equations (1), (2), and (3) described above.

Since N=53 in the case of the 53×53 bit integer multiplication, the area, height, and width are obtained as follows using the equations (1) to (3).
Area=2,756 (FAS)
Height=104 (FAS)
Width=106 (FAs)

The Wallace tree obtained in this manner has a size as illustrated in FIG. 5B.

As described above, in the present arithmetic circuit 1, the plurality of low-precision multipliers 3 and the auxiliary operator 4 are combined to form the high-precision multiplier 2.

Here, by combining the Wallace trees for a low-precision integer multiplier with the auxiliary operator 4 coupled thereto, a Wallace tree for an integer multiplier capable of supporting both low precision and high precision may be configured.

For example, by combining, as the low-precision multipliers 3, four Wallace trees for a 24×24 bit integer multiplier with the auxiliary operator 4 coupled thereto, for example, a Wallace tree for a 53×53 bit integer multiplier may be configured. The Wallace tree for a 53×53 bit integer multiplier configured in this manner functions as the high-precision multiplier 2.

For example, by using a circuit in which data of FP-32 is to be calculated as the low-precision multiplier 3 and combining it with the auxiliary operator 4 coupled thereto, the high-precision multiplier 2 in which data of FP-64 is to be calculated may be configured.

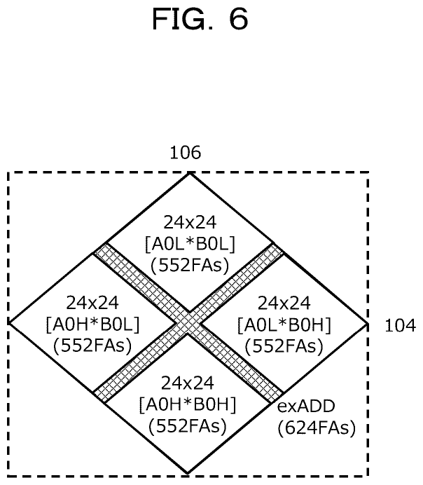

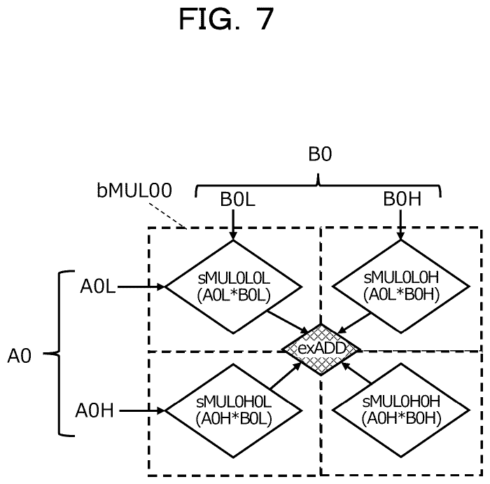

FIG. 6 is a diagram exemplifying the Wallace tree for a 53×53 bit integer multiplier including the four Wallace trees for a 24×24 bit integer multiplier, and FIG. 7 is a layout diagram of the Wallace tree exemplified in FIG. 6.

In those FIGS. 6 and 7, an example is illustrated in which the Wallace tree for a 53×53 bit integer multiplier is used as bMUL00 in FIG. 1.

In FIG. 6, the four Wallace trees for a 24×24 bit integer multiplier are respectively arranged at the four corners of the Wallace tree for a 53×53 bit integer multiplier having a rectangular (rhombus) shape.

Those four Wallace trees for a 24×24 bit integer multiplier correspond to the low-precision multipliers 3 (sMUL0L0L, sMUL0H0L, sMUL0L0H, and sMUL0H0H) in the arithmetic circuit 1 exemplified in FIG. 1.

In addition, the auxiliary operator 4 (exADD) is formed between the four Wallace trees for a 24×24 bit integer multiplier to fill a gap between the adjacent Wallace trees for a 24×24 bit integer multiplier. With this arrangement, each of the four Wallace tree for a 24×24 bit integer multiplier is coupled to the auxiliary operator 4.

In the example illustrated in FIGS. 6 and 7, the auxiliary operator 4 includes 624 full adders. In addition, each of the four low-precision multipliers 3 includes 552 full adders. Therefore, the high-precision multiplier 2 exemplified in FIGS. 6 and 7 includes 2,832 full adders.

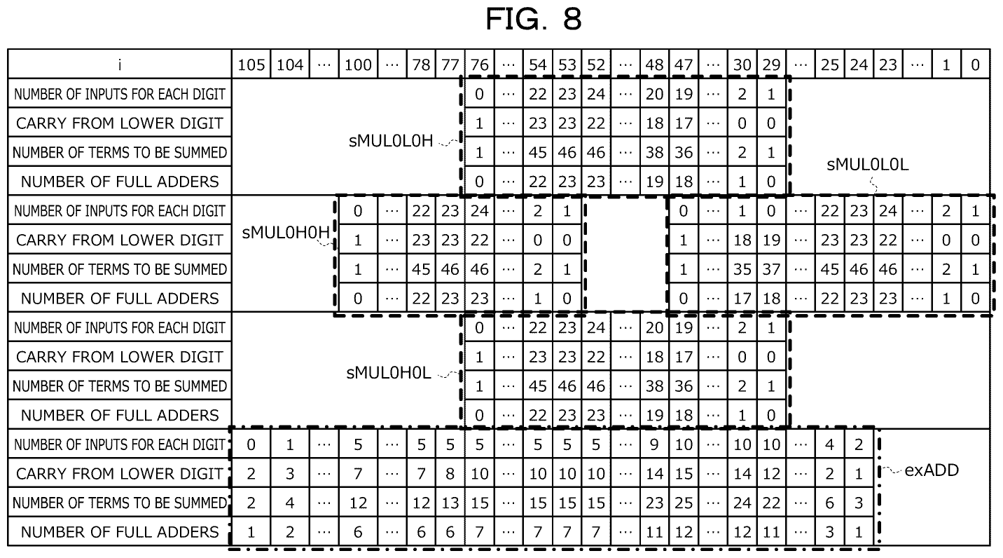

FIG. 8 is a diagram illustrating a configuration of each Wallace tree of the four low-precision multipliers 3 and the auxiliary operator 4 included in the Wallace tree for a 53×53 bit integer multiplier exemplified in FIGS. 6 and 7. This FIG. 8 illustrates numerical information indicating the configuration of the Wallace tree of the auxiliary operator 4 (exADD) together with numerical information indicating the configuration of each of the four Wallace trees for a 24×24 bit integer multiplier included in the Wallace tree for a 53×53 bit integer multiplier.

In the high-precision multiplier 2 exemplified in this FIG. 8, sMUL0L0H is arranged at the position of the upper bit digits 76 to 29, and sMUL0H0H is arranged at the position of the lower left bit digits 100 to 53 to be adjacent to a part (bit digits 76 to 53) of sMUL0L0H. In addition, sMUL0L0L is arranged at the position of the lower right bit digits 47 to 0 of sMUL0L0H, which is on the right side of sMUL0H0H, to be adjacent to a part (bit digits 47 to 29) of sMUL0L0H. In addition, sMUL0H0L is arranged at the position of the lower left bit digits 76 to 29 of sMUL0L0L, which is at the lower right of sMUL0H0H. This sMUL0H0L is arranged to be adjacent to a part (bit digits 76 to 53) of sMUL0H0H and also adjacent to a part (bit digits 47 to 29) of sMUL0L0L. As described above, in the bit addition configuration of the high-precision multiplier 2 exemplified in FIG. 8, the respective low-precision multipliers 3 are arranged with the full adder configuration for 24×24 bits shifted in bit digits.

Furthermore, on the lower side of sMUL0H0L, the auxiliary operator 4 (exADD) is arranged at the position of the bit digits 105 to 24 to be adjacent to sMUL0H0L. The auxiliary operator 4 has an input from each digit.

While the high-precision multiplier 2 (bMUL) has 2,809 (=53×53) bits of input, the four Wallace trees for a 24×24 bit integer multiplier have only 2,304 (=24×24×4) bits of input, and 505 bits of input are insufficient. This insufficient input bits are input to the auxiliary operator 4 (exADD). The auxiliary operator 4 performs digit alignment and addition on the input bits and the output bits of the four low-precision multipliers 3 using the Wallace tree, and outputs a 53×53 bit multiplication result.

Two-dimensionally arranging the Wallace trees for a low-precision integer multiplier above, below, left, and right of the rhombus of the Wallace tree for a high-precision integer multiplier matches the arrangement of the low-precision multipliers 3 in the two-dimensional systolic array configuration, and an effect of area reduction may be obtained also from the viewpoint of circuit layout.

As in the layout diagram illustrated in FIG. 7, by two-dimensionally arranging the Wallace trees (low-precision multipliers 3) for calculating A0 {L, H}*B0 {L, H} close to each other, it becomes possible to shorten the length of wiring to the auxiliary operator 4 and the length of wiring related to a carry, and to achieve a reduction in the circuit area and improvement in the circuit speed.

### (C) Effects

In the arithmetic circuit 1 configured as described above, the plurality of high-precision multipliers 2 (second operators), which includes the plurality of low-precision multipliers 3 (first operators) arranged in the lattice pattern and the auxiliary operator 4 coupled to each of those plurality of low-precision multipliers 3, is arranged in the lattice pattern. Furthermore, in each of the high-precision multipliers 2, each of the low-precision multipliers 3 performs multiplication (A #L*B #L, A #L*B #H, A #H*B #L, or A #H*B #H) between the submatrix generated by dividing the multiplier (A) of the matrix product and the submatrix generated by dividing the multiplicand (B) of the matrix product to calculate the submatrix product. Then, the auxiliary operator 4 performs the digit alignment and the addition of the submatrix product calculated by each of the individual low-precision multipliers 3.

As a result, multiplications of both of the plurality of degrees of precision (high precision and low precision) may be handled in one arithmetic circuit 1, whereby the circuit area may be reduced.

For example, the number of full adders of the Wallace tree for a 53×53 bit integer multiplier shared with the four 24×24 bit integer multipliers increases only 5% compared to the Wallace tree for a non-shared 53×53 bit integer multiplier. Furthermore, since the circuit delay is increased by only one stage of the full adder, the operation speed of the circuit is also equivalent.

Since most of the circuit area of the multiplier using the Wallace tree is commonly occupied by the Wallace tree, multiplications of both high precision and low precision may be handled in the present arithmetic circuit 1 with substantially the same circuit area and circuit delay as those of an arithmetic circuit that implements only the high-precision operation, whereby the effect of reducing the circuit area is particularly large.

Furthermore, the arithmetic circuit 1 may operate by switching between two calculation modes including the low-precision calculation mode (first calculation mode) for processing low-precision (first precision) data and the high-precision calculation mode (second calculation mode). Then, in the low-precision calculation mode, the addition of the submatrix product calculated by each of all the low-precision multipliers 3 included in the present arithmetic circuit 1 is performed, whereby the low-precision matrix product operation may be performed. Furthermore, in the high-precision calculation mode, the addition of the calculation result of each of the auxiliary operators 4 included in the plurality of high-precision multipliers 2 is performed, whereby the high-precision matrix product operation may be performed.

Moreover, since each of the low-precision multipliers 3 is a circuit in which data of FP-32 is to be calculated, and each of the high-precision multipliers 2 is a circuit in which data of FP-64 is to be calculated, the operation of the matrix product of FP-32 and the operation of the matrix product of FP-64 may be performed in the arithmetic circuit 1.

Furthermore, since each of the low-precision multipliers 3 is a partial product adder circuit formed using the Wallace tree, the arithmetic circuit 1 that handles both the low-precision matrix product operation and the high-precision matrix product operation may be reliably implemented.

### (D) Others

Note that various modifications may be made without departing from the gist of the present embodiment regardless of the embodiment described above.

For example, while the embodiment described above adopts the configuration in which the high-precision multiplier 2 includes the four low-precision multipliers 3 so that the circuit is shared by the four low-precision multipliers 3 and one high-precision multiplier 2, it is not limited to this. For example, in the two-dimensional systolic array configuration in which the low-precision multiplier 3 is a circuit in which the data of FP-32 is to be calculated and the high-precision multiplier 2 is a circuit in which the data of FP-64 is to be calculated, the low-precision multiplier 3 may be further divided into four half-precision (e.g., FP-16) multipliers to configure 16 (=4×4) half-precision multipliers.

Furthermore, in the embodiment described above, a circuit for calculating the data of FP-32 is used as the low-precision multiplier 3, and the auxiliary operator 4 coupled thereto is combined, whereby the high-precision multiplier 2 for calculating the data of FP-64 is configured. For example, while the example is described in which the low-precision multiplier 3 is a circuit in which the data of FP-32 is to be calculated and the high-precision multiplier 2 is a circuit in which the data of FP-64 is to be calculated, it is not limited to this.

For example, a circuit for calculating the data of FP-16 may be used as the low-precision multiplier 3, and the high-precision multiplier 2 may be a circuit for calculating the data of FP-32. With this arrangement, the operation of the matrix product of FP-16 and the operation of the matrix product of FP-32 may be performed in the arithmetic circuit 1.

Furthermore, a circuit for calculating 8-bit floating point data may be used as the low-precision multiplier 3, and the high-precision multiplier 2 may be a circuit for calculating the data of FP-16. With this arrangement, the operation of the matrix product of the 8-bit floating point and the operation of the matrix product of FP-16 may be performed in the arithmetic circuit 1.

Furthermore, those skilled in the art may carry out or manufacture the present embodiment according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A matrix arithmetic circuit that performs an operation of a matrix product, the matrix arithmetic circuit comprising:
a plurality of second operators, each of which includes a plurality of first operators and an auxiliary operator coupled to each of the plurality of first operators, arranged in a lattice pattern, wherein
in each of the plurality of second operators,
each of the plurality of first operators multiplies a submatrix generated by dividing a multiplier of the matrix product by a submatrix generated by dividing a multiplicand to calculate a submatrix product, and
the auxiliary operator performs digit alignment and addition of the submatrix product calculated by each of the plurality of first operators.

2. The matrix arithmetic circuit according to claim 1, wherein
the matrix arithmetic circuit is operable by switching between two calculation modes of a first calculation mode that processes data with a first precision and a second calculation mode that processes data with a second precision higher than the first precision,
in the first calculation mode, the addition of the submatrix product calculated by each of all the plurality of first operators included in the matrix arithmetic circuit is performed, and
in the second calculation mode, addition of a calculation result of each of the auxiliary operators of the plurality of second operators is performed.

3. The matrix arithmetic circuit according to claim 1, wherein
each of the plurality of first operators includes a circuit in which data of 32-bit floating point is to be calculated, and
each of the plurality of second operators includes a circuit in which data of 64-bit floating point is to be calculated.

4. The matrix arithmetic circuit according to claim 1, wherein
each of the plurality of first operators includes a circuit in which data of 16-bit floating point is to be calculated, and
each of the plurality of second operators includes a circuit in which data of 32-bit floating point is to be calculated.

5. The matrix arithmetic circuit according to claim 1, wherein
each of the plurality of first operators includes a circuit in which 8-bit floating point data is to be calculated, and
each of the plurality of second operators includes a circuit in which data of 32-bit floating point is to be calculated.

6. The matrix arithmetic circuit according to claim 1, wherein
each of the plurality of first operators includes a partial product adder circuit formed by using a Wallace tree.

7. The matrix arithmetic circuit according to claim 1, wherein
the plurality of first operators is arranged in the lattice pattern.
